(19) United States
(12) Patent Application Publication
(10) Pub. No.: US 2024/0149892 A1
(43) Pub. Date: May 9, 2024

(54) METHODS AND APPARATUS FOR SAFELY OPERATING AUTONOMOUS VEHICLES

(71) Applicant: Nuro, Inc., Mountain View, CA (US)

(72) Inventors: Aashi Arun, Newark, CA (US); Heba Mustufa, Mountain View, CA (US); Ivan Cheng, Irvine, CA (US); Quresh Sutarwala, Fremont, CA (US)

(73) Assignee: Nuro, Inc., Mountain View, CA (US)

(21) Appl. No.: 18/473,576

(22) Filed: Sep. 25, 2023

Related U.S. Application Data
(60) Provisional application No. 63/422,779, filed on Nov. 4, 2022.

(51) Int. Cl. B60W 50/029; B60W 50/02; B60W 60/00

(52) U.S. Cl. CPC B60W 50/029; B60W 50/0205; B60W 60/0015

(57) ABSTRACT

According to one aspect, a method includes identifying, using a vehicle control system (VCS) of a vehicle, an issue associated with the vehicle. A criticality level of the issue is determined using the VCS, and the VCS determines at least one action to perform based on the criticality level. Determining the at least one action to perform includes determining whether to accept a first trajectory update generated by the trajectory generation system. The method also includes performing the at least one action, wherein performing the at least one action includes updating the trajectory using the first trajectory update when it is determined that the first trajectory update is be accepted, and wherein performing the at least one action further includes declining the first trajectory update when it is determined that the first trajectory update is not to be accepted.

### PRIORITY CLAIM

This patent application claims the benefit of priority under 35 U.S.C. § 119 to U.S. Provisional Patent Application No. 63/422,779, filed Nov. 4, 2022, and entitled “METHODS AND APPARATUS FOR SAFELY OPERATING AUTONOMOUS VEHICLES AND PLATFORMS,” which is incorporated herein by reference in its entirety.

### TECHNICAL FIELD

The disclosure relates to providing systems for use with autonomous vehicles. More particularly, the disclosure relates to the safe operation of autonomous vehicles that are part of autonomous vehicle platforms in the event that issues such as failures and/or faults are detected.

### BACKGROUND

Fleets of vehicles may be included in an autonomous vehicle platform or a robotic platform. The vehicles and/or robotic systems may be capable of operating autonomously or semi-autonomously. Systems and components which enable vehicles and/or robotic systems to operate autonomously or semi-autonomously are typically complex. The increasing complexity of such systems and components effectively requires intelligent and sophisticated solutions to handle failures, faults, errors, exceptions, and/or degradations in performance associated with such systems and components. Safely handling, e.g., mitigating, failures and/or faults enables autonomous vehicles to operate in a safe manner.

### BRIEF DESCRIPTION OF THE DRAWINGS

The disclosure will be readily understood by the following detailed description in conjunction with the accompanying drawings in which:

FIG. 1 is a diagrammatic representation of an autonomous vehicle fleet in accordance with an embodiment.

FIG. 2 is a diagrammatic representation of a side of an autonomous vehicle in accordance with an embodiment.

FIG. 3 is a block diagram representation of an autonomous vehicle in accordance with an embodiment.

FIG. 4 is a block diagram representation of a vehicle control system. e.g., vehicle control system 338 of FIG. 3, in accordance with an embodiment.

FIG. 5 is a block diagram representation of a vehicle that includes a vehicle control system, e.g., vehicle control system 338 of FIGS. 3 and 4, in accordance with an embodiment.

FIG. 6 is a process flow diagram which illustrates a method of a vehicle control system operating in accordance with an embodiment.

FIG. 7 is a process flow diagram which illustrates a method of a vehicle control system causing a vehicle to take an action based on a non-critical or non-urgent issue, e.g., step 629 of FIG. 6, in accordance with an embodiment.

FIG. 8 is a process flow diagram which illustrates a method of a vehicle control system causing a vehicle to take an action based on a critical or urgent issue, e.g., step 629 of FIG. 6, in accordance with an embodiment.

FIGS. 9A-C are a process flow diagram which illustrates a method of a vehicle control system causing a vehicle to take an action based on an “intermediate” issue, e.g., step 629 of FIG. 6, in accordance with an embodiment.

FIG. 10 is a block diagram representation of an issue or fault level determination arrangement, e.g., issue level determination arrangement 438a of FIG. 4, in accordance with an embodiment.

### DESCRIPTION OF EXAMPLE EMBODIMENTS

### General Overview

According to one aspect, a method includes identifying, using a vehicle control system (VCS) of a vehicle, an issue associated with the vehicle, the vehicle including a trajectory generation system, the vehicle being configured to follow a trajectory generated by the trajectory generation system. The method also includes determining, using the VCS, a criticality level of the issue and determining, using the VCS, at least one action to perform with respect to the vehicle, the at least one action being associated with the criticality level, wherein determining the at least one action to perform includes determining whether to accept a first trajectory update generated by the trajectory generation system. Finally, the method includes performing the at least one action, wherein performing the at least one action includes updating the trajectory using the first trajectory update when it is determined that the first trajectory update is be accepted, and wherein performing the at least one action further includes declining the first trajectory update when it is determined that the first trajectory update is not to be accepted.

In accordance with another aspect, a vehicle includes logic encoded in one or more tangible non-transitory, computer-readable media for execution and when executed operable to generate a trajectory to be followed by the vehicle, wherein the logic operable to generate the trajectory is further operable to generate at least a first trajectory update and to use the first trajectory update to update the trajectory. The logic is also operable to identify an issue associated with the vehicle, determine a criticality level of the issue, and determine at least one action to perform with respect to the vehicle, the at least one action being associated with the criticality level, wherein the logic operable to determine the at least one action to perform is operable to determine whether to accept the first trajectory update. The logic is further operable to perform the at least one action, wherein the logic operable to perform the at least one action includes logic operable to update the trajectory using the first trajectory update when it is determined that the first trajectory update is be accepted, and wherein the logic operable to perform the at least one action is further operable to decline the first trajectory update when it is determined that the first trajectory update is not to be accepted.

In accordance with still another aspect, a vehicle includes a chassis, a propulsion system configured to propel the chassis, a trajectory generation system, and a vehicle control system. The trajectory generation system is configured to generate at least one trajectory update and a trajectory to be followed by the vehicle. The vehicle control system includes a trajectory execution arrangement configured to execute the trajectory, and the vehicle control system further includes an issue determination arrangement configured to identify an issue associated with the trajectory generation system, to identify a category for the issue, and to perform at least one action based on the category.

A vehicle, which may be an occupantless vehicle or may be a vehicle that is configured to carry occupants, may include a vehicle control system configured to detect faults within trajectory generation systems and/or other vehicle systems. Trajectory generation systems may include a primary autonomy system, a backup autonomy system, and/or teleoperations interface. In response to detecting a fault, a vehicle control system may determine whether the fault is a non-critical fault that enables the vehicle to continue operating, a critical fault that effectively requires the vehicle to perform an immediate stop, or an intermediate fault that allows the vehicle to operate for a period of time to identify a safe stopping location and come to a controlled, safe stop. Upon essentially classifying a fault, a vehicle control system may then cause a vehicle to function in accordance with the classification of the fault. That is, the vehicle control system may implement an action associated with the type of fault that has been identified.

### DESCRIPTION

The safe operation of an apparatus such as an autonomous vehicle or an autonomous robotic system is critical. In order for an autonomous vehicle or an autonomous robotic system to operate safely, e.g., operate without endangering bystanders, systems on the vehicle or robotic system may take one or more actions upon detecting an issue associated with the vehicle or robotic system such as a failure, a fault, an error, an exception, and/or a degradations in performance.

In one embodiment, an autonomous vehicle or autonomous robotic system may, upon detecting an issue that has an effect on the generation of a trajectory to be followed by the autonomous vehicle or autonomous robotic system, essentially classify the issue and take an action that is consistent with the issue. A framework or platform may be configured to determine the severity of particular issues, classify the issues, and identify suitable actions to take to address the issues. Some issues may severely compromise the ability for an autonomous vehicle to operate safely, while other issues may have a relatively insignificant effect on the ability for an autonomous vehicle to operate safely. For issues that severely compromise the ability for an autonomous vehicle to operate safely, the autonomous vehicle may be stopped substantially immediately. For issues that have less of an effect on the ability of an autonomous vehicle to operate safely, the autonomous vehicle may be allowed to continue operating, at least temporarily, as for example until a suitable location at which the vehicle may come to a safe stop is located.

A vehicle control system of an autonomous vehicle may receive trajectory information, e.g., trajectory updates, while operating. That is, a vehicle, while operating along a particular trajectory, may receive or otherwise obtain trajectory updates as more information, e.g., more current information, becomes available. The trajectory updates may be obtained or otherwise received from one or more trajectory generation systems of the vehicle. Each trajectory generation system may substantially independently generate trajectory updates for controlling the trajectory of a vehicle while the vehicle operates autonomously. When issues are detected within a vehicle, the processing of trajectory updates may be affected. In one embodiment, trajectory updates may be substantially disregarded when an issue that has a significant effect on the ability of the vehicle to operate safely is identified. In another embodiment, when a vehicle has an issue that does not have a significant effect on the ability of the vehicle to operate safely, one or more trajectory generation systems of the vehicle may be provided with information relating to the fault such that subsequent trajectory updates may effectively account for the issue.

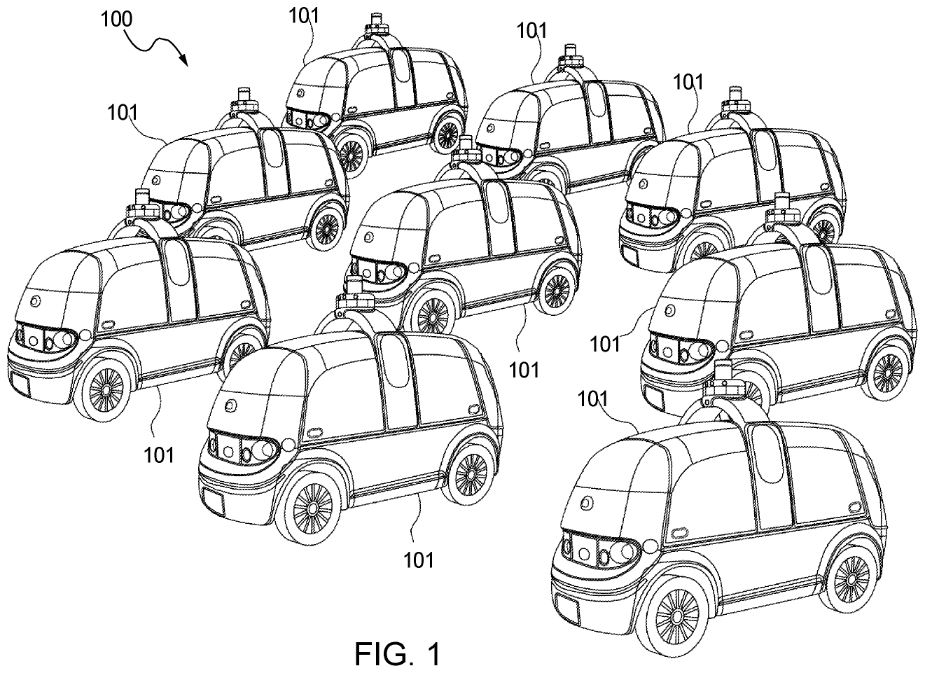

Autonomous vehicles which classify issues and process trajectory updates according to the criticality of the issues may generally be part of a fleet of vehicles that includes one or more autonomous vehicles. Referring initially to FIG. 1, an autonomous vehicle fleet will be described in accordance with an embodiment. An autonomous vehicle fleet 100 includes a plurality of autonomous vehicles 101, or robot vehicles. Autonomous vehicles 101 are generally arranged to transport and/or to deliver cargo, items, and/or goods. Autonomous vehicles 101 may be fully autonomous and/or semi-autonomous vehicles. In general, each autonomous vehicle 101 may be a vehicle that is capable of travelling in a controlled manner for a period of time without intervention, e.g., without human intervention. As will be discussed in more detail below, each autonomous vehicle 101 may include a power system, a propulsion or conveyance system, a navigation module, a control system or controller, a communications system, a processor, and a sensor system.

Dispatching of autonomous vehicles 101 in autonomous vehicle fleet 100 may be coordinated by a fleet management module (not shown). The fleet management module may dispatch autonomous vehicles 101 for purposes of transporting, delivering, and/or retrieving goods or services in an unstructured open environment or a closed environment.

While autonomous vehicle fleet 100 includes one or more autonomous vehicles 101 which are generally configured to transport and/or to deliver cargo, items, and/or goods, it should be appreciated that autonomous vehicle fleet 100 is not limited to including one or more autonomous vehicles 101. For example, autonomous vehicle fleet 100 may additionally, or alternatively, include autonomous vehicles (not shown) which are configured to transport and/or to deliver passengers.

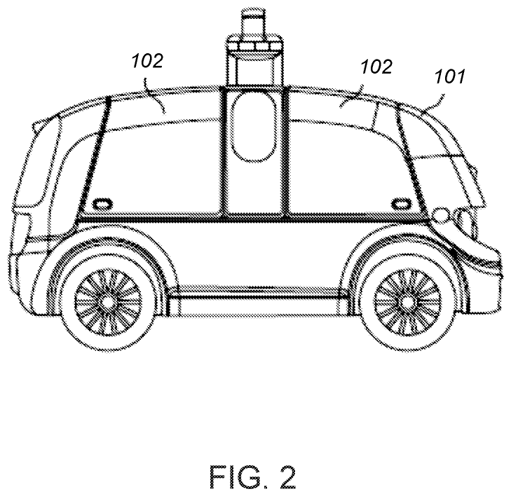

FIG. 2 is a diagrammatic representation of a side of an autonomous vehicle, e.g., one of autonomous vehicles 101 of FIG. 1, in accordance with an embodiment. Autonomous vehicle 101, as shown, is a vehicle configured for land travel. Typically, autonomous vehicle 101 includes physical vehicle components such as a body or a chassis, as well as conveyance mechanisms, e.g., wheels. In one embodiment, autonomous vehicle 101 may be relatively narrow, e.g., approximately two to approximately five feet wide, and may have a relatively low mass and relatively low center of gravity for stability. Autonomous vehicle 101 may be arranged to have a working speed or velocity range of between approximately one and approximately forty-five miles per hour (mph), e.g., approximately twenty-five miles per hour. In some embodiments, autonomous vehicle 101 may have a substantially maximum speed or velocity in range between approximately thirty and approximately ninety mph.

Autonomous vehicle 101 includes a plurality of compartments 102. Compartments 102 may be assigned to one or more entities, such as one or more customer, retailers, and/or vendors. Compartments 102 are generally arranged to contain cargo, items, and/or goods. Typically, compartments 102 may be secure compartments. It should be appreciated that the number of compartments 102 may vary. That is, although two compartments 102 are shown, autonomous vehicle 101 is not limited to including two compartments 102.

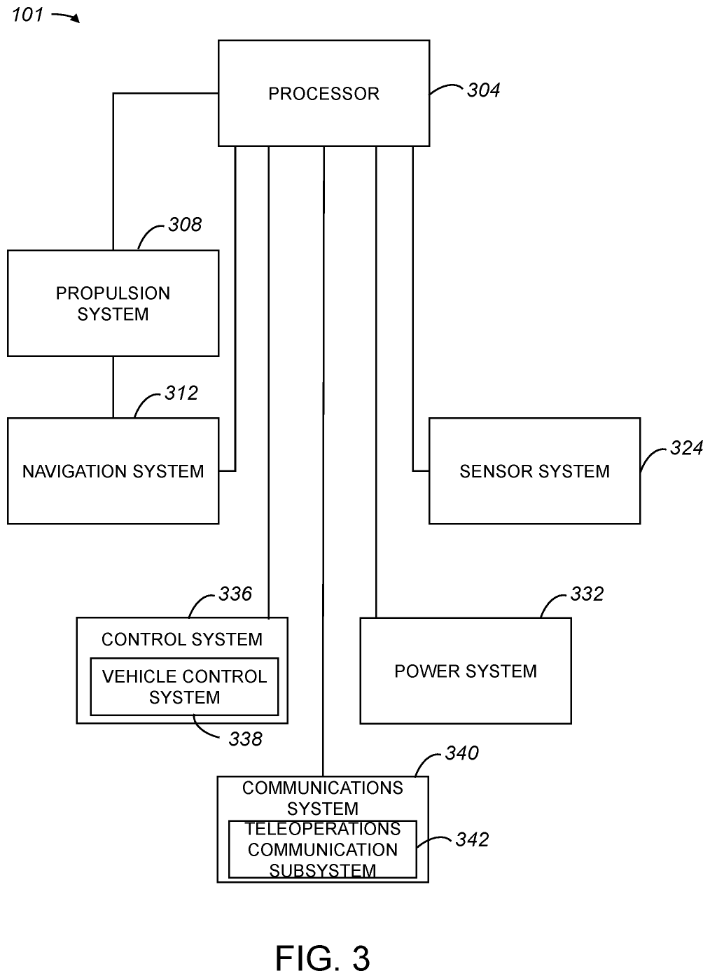

FIG. 3 is a block diagram representation of an autonomous vehicle, e.g., autonomous vehicle 101 of FIG. 1, in accordance with an embodiment. An autonomous vehicle 101 includes a processor 304, a propulsion system 308, a navigation system 312, a sensor system 324, a power system 332, a control system 336, and a communications system 340. It should be appreciated that processor 304, propulsion system 308, navigation system 312, sensor system 324, power system 332, and communications system 340 are all coupled to a chassis or body of autonomous vehicle 101.

Processor 304 is arranged to send instructions to and to receive instructions from or for various components such as propulsion system 308, navigation system 312, sensor system 324, power system 332, and control system 336. Propulsion system 308, or a conveyance system, is arranged to cause autonomous vehicle 101 to move, e.g., drive. For example, when autonomous vehicle 101 is configured with a multi-wheeled automotive configuration as well as steering, braking systems and an engine, propulsion system 308 may be arranged to cause the engine, wheels, steering, and braking systems to cooperate to drive. In general, propulsion system 308 may be configured as a drive system with a propulsion engine, wheels, treads, wings, rotors, blowers, rockets, propellers, brakes, etc. The propulsion engine may be a gas engine, a turbine engine, an electric motor, and/or a hybrid gas and electric engine.

Navigation system 312 may control propulsion system 308 to navigate autonomous vehicle 101 through paths and/or within unstructured open or closed environments. Navigation system 312 may include at least one of digital maps, street view photographs, and a global positioning system (GPS) point. Maps, for example, may be utilized in cooperation with sensors included in sensor system 324 to allow navigation system 312 to cause autonomous vehicle 101 to navigate through an environment.

Sensor system 324 includes any sensors, as for example LiDAR, radar, ultrasonic sensors, microphones, altimeters, and/or cameras. Sensor system 324 generally includes onboard sensors which allow autonomous vehicle 101 to safely navigate, and to ascertain when there are objects near autonomous vehicle 101. In one embodiment, sensor system 324 may include propulsion systems sensors that monitor drive mechanism performance, drive train performance, and/or power system levels. Data collected by sensor system 324 may be used by a perception system associated with navigation system 312 to determine or to otherwise understand an environment around autonomous vehicle 101.

Power system 332 is arranged to provide power to autonomous vehicle 101. Power may be provided as electrical power, gas power, or any other suitable power, e.g., solar power or battery power. In one embodiment, power system 332 may include a main power source, and an auxiliary power source that may serve to power various components of autonomous vehicle 101 and/or to generally provide power to autonomous vehicle 101 when the main power source does not have the capacity to provide sufficient power.

Communications system 340 allows autonomous vehicle 101 to communicate, as for example, wirelessly, with a fleet management system (not shown) that allows autonomous vehicle 101 to be controlled remotely. Communications system 340 generally obtains or receives data, stores the data, and transmits or provides the data to a fleet management system and/or to autonomous vehicles 101 within a fleet 100. The data may include, but is not limited to including, information relating to scheduled requests or orders, information relating to on-demand requests or orders, and/or information relating to a need for autonomous vehicle 101 to reposition itself, e.g., in response to an anticipated demand. In one embodiment, communications system 340 includes a teleoperations communications subsystem 342. Teleoperations communications subsystem 342 may include multiple modems, e.g., cellular modems such as LTE or 3G/4G/5G modems, which are arranged to cooperate to communicate with a fleet operations system (not shown) such that a teleoperations system of the fleet operations system may monitor and operate autonomous vehicle 101 remotely. It should be appreciated that teleoperations communications subsystem 342 may alternatively, or additionally, communicate substantially directly with a teleoperations system (not shown).

In some embodiments, control system 336 may cooperate with processor 304 to determine where autonomous vehicle 101 may safely travel, and to determine the presence of objects in a vicinity around autonomous vehicle 101 based on data, e.g., results, from sensor system 324. In other words, control system 336 may cooperate with processor 304 to effectively determine what autonomous vehicle 101 may do within its immediate surroundings. Control system 336 in cooperation with processor 304 may essentially control power system 332 and navigation system 312 as part of driving or conveying autonomous vehicle 101. Additionally, control system 336 may cooperate with processor 304 and communications system 340 to provide data to or obtain data from other autonomous vehicles 101, a management server, a global positioning server (GPS), a personal computer, a teleoperations system, a smartphone, or any computing device via the communication module 340. In general, control system 336 may cooperate at least with processor 304, propulsion system 308, navigation system 312, sensor system 324, and power system 332 to allow vehicle 101 to operate autonomously. That is, autonomous vehicle 101 is able to operate autonomously through the use of an autonomy system that effectively includes, at least in part, functionality provided by propulsion system 308, navigation system 312, sensor system 324, power system 332, and control system 336. Components of propulsion system 308, navigation system 312, sensor system 324, power system 332, and control system 336 may effectively form a perception system that may create a model of the environment around autonomous vehicle 101 to facilitate autonomous or semi-autonomous driving. It should be appreciated that control system 336 obtains information from navigation system 312, as well as pose and motion planning systems, to generate commands that may be used by propulsion system 308, as well as a steering system and a braking system.

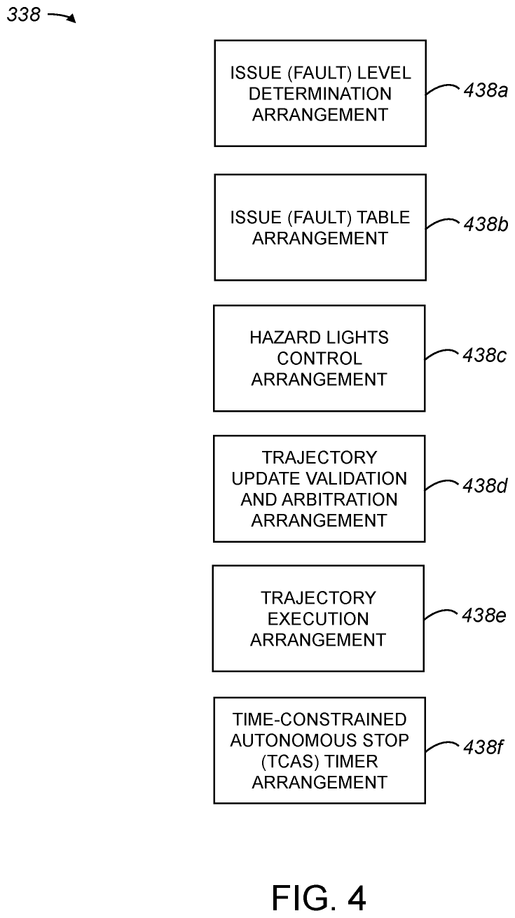

In one embodiment, control system 336 includes a vehicle control system 338 that is configured to identify issues encountered by vehicle 101. Vehicle control system 338 may determine when an issue exists, determine the severity of the issue, and determine a response to take to address the issue. To determine a response or course of action to respond to the issue, vehicle control system 338 may identify a trajectory update and substantially ascertain whether to accept or to decline the trajectory update. One embodiment of vehicle control system 338 will be discussed below with respect to FIG. 4.

As will be appreciated by those skilled in the art, when autonomous vehicle 101 operates autonomously, vehicle 101 may generally operate, e.g., drive, under the control of an autonomy system. That is, when autonomous vehicle 101 is in an autonomous mode, autonomous vehicle 101 is able to generally operate without a driver or a remote operator controlling autonomous vehicle. In one embodiment, autonomous vehicle 101 may operate in a semi-autonomous mode or a fully autonomous mode. When autonomous vehicle 101 operates in a semi-autonomous mode, autonomous vehicle 101 may operate autonomously at times and may operate under the control of a driver or a remote operator at other times. When autonomous vehicle 101 operates in a fully autonomous mode, autonomous vehicle 101 typically operates substantially only under the control of an autonomy system. The ability of an autonomous system to collect information and extract relevant knowledge from the environment provides autonomous vehicle 101 with perception capabilities. For example, data or information obtained from sensor system 324 may be processed such that the environment around autonomous vehicle 101 may effectively be perceived.

An autonomous vehicle that includes a vehicle control system such as vehicle control system 338 may detect issues such as failures and faults, and substantially categorize the issues in terms of criticality. The issues may potentially compromise the ability for a trajectory to be generated for the autonomous vehicle to follow. By categorizing issues in terms of criticality, appropriate actions taken to address the issues may be based upon how critical the issues are. As a result, issues that are relatively critical may be addressed in a different manner than issues that are relatively non-critical, and the efficiency with which autonomous vehicles operate may be improved. For example, when a critical issue is detected or otherwise identified, a vehicle control system may cause a vehicle to disregard trajectory updates and to bring the vehicle to a stop using relatively robust back-up and/or failover trajectories. On the other hand, when a non-critical issue is detected or otherwise identified, a vehicle control system may continue to process trajectory updates and continue to operate. In the event that an “intermediate” issue, e.g., an issue that is neither non-critical nor critical, is identified, a vehicle control system may obtain information related to the issue to provide trajectory updates which enable the vehicle to operate for a predetermined amount of time before coming to a safe stop.

A critical or urgent issue may be an issue that has a significant effect on the ability of a vehicle to operate safely, and may include both physical issues with the vehicle and issues which may result in harm to humans, animals, and/or property. For example, non-recoverable faults such as failure of a compute system or a loss of redundancy on a vehicle may be a critical or urgent issue, and an imminent collision with another vehicle may be a critical or urgent issue. A non-critical or non-urgent issue may include faults that essentially do not affect drive performance, e.g., an interior light that is not functioning or an initial brake pad warning. A non-critical or non-urgent issue may be an issue that degrades vehicle performance and substantially may not be corrected without assistance, or an issue associated with a vehicle substantially exceeding predetermined limits while systems such as actuators remain healthy. A non-urgent issue may also be a brake pad warning from a brakes subsystem or an indication that allow voltage battery is unable to store charge as well as expected, or an issue with a vehicle door being open while a trajectory generation system requests motion. An intermediate issue may be an issue that causes a degradation in vehicle performance, but may be substantially cleared by the vehicle substantially without assistance. By way of example, an intermediate issue may include a motor controller overcurrent fault or an overheated module, as well as an issue in which a vehicle acceleration does not substantially match or is otherwise inconsistent with a trajectory being executed. In one embodiment, an external disturbance like wind may be an intermediate issue, as wind may cause a relatively instantaneous spike in vehicle trajectory tracking performance, but the wind may be mitigated by a trajectory generation position estimation scheme. Sensor drift such as sensor drift associated with an internal measurement unit may also be an intermediate issue.

With reference to FIG. 4, one embodiment of a vehicle control system, e.g., vehicle control system 338 of FIG. 3, will be described in accordance with an embodiment. Vehicle control system 338, which may be embodied as hardware and/or software logic embodied on a computer-readable medium, includes an issue level determination arrangement 438a, an issue table arrangement 438b, a hazard lights control arrangement 438c, a trajectory update validation and arbitration arrangement 438d, a trajectory execution arrangement 438e, and a time-constrained autonomous stop (TCAS) timer arrangement 438f.

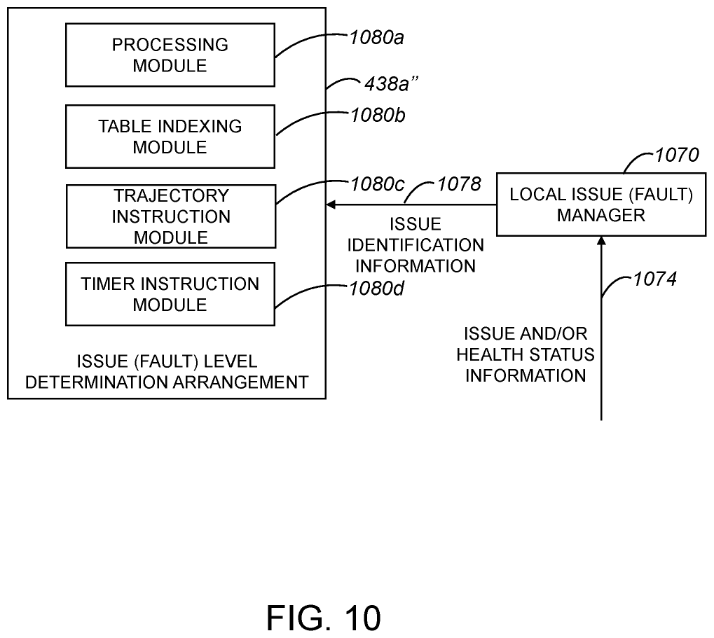

Issue level determination arrangement 438a is configured to determine when there is a detected issue, and to determine a level for a detected issue, e.g., a criticality measure for a failure or a fault detected by sensors on a vehicle such as vehicle 101. A vehicle such as vehicle 101 may have different subsystems including, but not limited to including, braking, steering, propulsion, high voltage power, and low voltage power subsystems, and issues associated with the subsystems may be detected when statuses associated with the subsystems are not expected or may be incorrect. Issues may also be detected when trajectory inputs are inconsistent with trajectory requests or vehicle capability limits. An issue may be detected within software features that check for signal validity during input processing. In one embodiment, multiple monitors and a vehicle monitoring system may detect motion and behavior anomalies. Issue level determination arrangement 438a may utilize issue table arrangement 438b to identify a level for a detected issue. In one embodiment, issue table arrangement 438b may provide a mapping between a type of issue and a level of criticality for the particular type of issue. That is, issue level determination arrangement 438a may use a detected issue as an index into issue table arrangement 438b to obtain a criticality level for the detected issue. Issue level determination arrangement 438a may monitor systems within a vehicle such as vehicle 101 of FIGS. 2 and 3 to detect or to otherwise identify faults, errors, failures, exceptions, and/or degradations in performance in those systems. Issue level determination arrangement 438a may, for example, obtain fault codes from systems within a vehicle and perform a lookup of the fault code in issue table arrangement 438b. One embodiment of issue level determination arrangement 438a will be discussed below with respect to FIG. 10.

Hazard lights control arrangement 438c is configured to activate vehicle hazard lights to indicate to bystanders, e.g., road users such as pedestrians or vehicles, of a potential issue. For example, hazard lights control arrangement 438c may activate vehicle hazard lights for certain types of issues by causing the vehicle hazard lights to blink or flash.

Trajectory update validation and arbitration arrangement 438d is configured to obtain trajectory updates. A trajectory update may be validated using any suitable criteria including, but not limited to including, a current trajectory of a vehicle. For example, a trajectory update may be validated based upon whether the components of the trajectory update such as a velocity spline and/or a direction spline effectively satisfy one or more criteria such as a velocity limit. Alternatively, a trajectory update may be validated based upon whether the trajectory update satisfies one or more timing criteria, a vehicle status, and/or a speed limit.

Trajectory update and arbitration arrangement 438d may also arbitrate between two or more trajectory updates obtained from trajectory generation systems to effectively determine which trajectory update, if any, is to be used to update a vehicle trajectory. Arbitrating multiple trajectory updates may include prioritizing the trajectory updates based on the source from which each of the trajectory updates is obtained, prioritizing the trajectory updates based the health of the source from which each of the trajectory updates is obtained, and/or, prioritizing the trajectory updates based on the status of a connections such as a connection associated with an autonomy system and a connection associated with a teleoperations system.

Trajectory execution arrangement 438e is generally arranged to update a trajectory based on a trajectory update substantially selected by trajectory update and arbitration arrangement 438d. Trajectory execution arrangement 438e may also be configured to generate one or more control signals that control systems associated with a vehicle.

TCAS timer arrangement 438f may be configured to facilitate the performance of a controlled safe stop of a vehicle when an action to be taken by the vehicle indicates that the vehicle is to come to a stop. TCAS timer arrangement 438f may be configured to provide a time interval within which a vehicle is to stop, and/or to implement a vehicle stop within a time interval. In general, once a vehicle has come to a safe stop, further motion of the vehicle is not allowed until the issue which instigated the safe stop has been resolved, e.g., cleared.

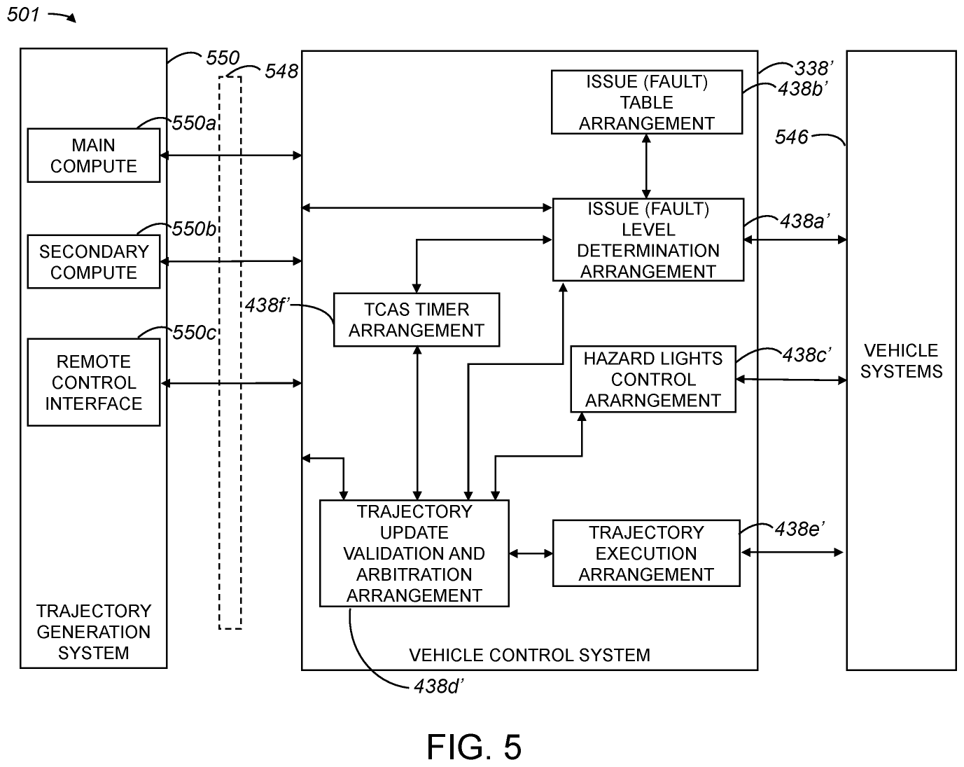

As mentioned above, vehicle control system 338 is part of vehicle 101 of FIGS. 2 and 3. Vehicle control system 338 may interact with an autonomy system of a vehicle 101, which may be substantially instantiated as part of multiple systems in vehicle 101. FIG. 5 is a block diagram representation of a vehicle that includes a vehicle control system, e.g., vehicle control system 338 of FIGS. 3 and 4, in accordance with an embodiment. A vehicle 501 generally includes systems included in vehicle 101 of FIGS. 2 and 3, including vehicle control system 338′. Vehicle 501 also includes vehicle systems 546 and one or more trajectory generation systems 550. Vehicle systems 546 may include, but are not limited to including, a drivetrain, braking mechanisms, steering mechanisms, and/or light systems such as a hazard light system. Trajectory generation systems 550 generally include systems which may generate a trajectory to be followed by vehicle 501 as well as provide trajectory updates.

In the embodiment as shown, trajectory generation systems 550 include a main compute 550a, a secondary compute 550b, and a remote control interface 550c. Main compute 550a may include an autonomy system that is configured to generate a trajectory as well as trajectory updates. Secondary compute 550b may include a backup autonomy system that is configured to provide backup in the event of an issue with the autonomy system included in main compute 550a. Secondary compute 550a may also include a teleoperations interface that is configured to obtain a trajectory and/or trajectory updates from a teleoperations system (not shown) that is external to vehicle 501 and arranged to remotely operate vehicle 501. Remote control interface 550c is arranged to obtain a trajectory and/or trajectory updates from a remote controller (not shown) that may be used to command vehicle 501.

Issue level determination arrangement 438a′ may monitor trajectory generation system 550 to identify potential issues such as faults or failures. In other words, issue level determination arrangement 438a′ may communicate with trajectory generation system 550 such that issue level determination arrangement 438a′ may effectively monitor the health and the status of trajectory generation system 550 such that issues may be detected.

Trajectory updates 548 provided by trajectory generation system 550 are obtained by vehicle control system 338′ for processing. In one embodiment, trajectory updates 348 may be provided to issue level determination arrangement 438a′ and trajectory update validation and arbitration arrangement 438d′. Upon substantially processing trajectory updates, issue level determination arrangement 438a′, hazard lights control arrangement 438c′ and trajectory execution arrangement 438e′ may provide output to vehicle systems 546 which may then implement the commands associated with the output. For example, vehicle systems 546 may execute a trajectory provided by trajectory execution arrangement 438e′.

In general, vehicle control system 338′ may obtain trajectory updates 548 that are intended to substantially control vehicle 501. Vehicle control system 338′ may effectively verify that each trajectory update 548 that is received or otherwise obtained from trajectory generation systems 550 is valid, and arbitrate among trajectory updates 550 to select one trajectory update 550 to be used to update a trajectory of vehicle 501, update the trajectory of vehicle 501 based on selected trajectory update 548, and generate outputs or control signals to provide to vehicle systems 546 such that vehicle 501 may follow the updated trajectory.

The trajectory of vehicle 501 may include multiple components including, but not limited to including, a velocity component or spline, an acceleration component or spline, and/or a direction component such as a directional or rotational spline. Similarly, trajectory updates 548 may include one or more components including, but not limited to including, a velocity component or velocity update spline, an acceleration component or acceleration update spline, and/or a direction component such as a directional update or rotational update spline.

Trajectory updates 548 may be obtained by vehicle control system 338′ in a synchronous manner, e.g., in accordance with a trajectory update schedule or interval, or in an asynchronous manner, e.g., out of sync with a defined trajectory update schedule or interval.

Vehicle control system 338′ may be configured to substantially contemporaneously obtain multiple trajectory updates 548 from multiple trajectory generation systems 550. Once trajectory updates 548 are obtained, trajectory update validation and arbitration arrangement 438d′ may arbitrate between or among trajectory updates 548 to determine respective priorities and to process trajectory updates 548 based on the respective priorities. For example, a velocity spline of a trajectory may be updated based on a velocity update spline associated with trajectory updates 548. As will be understood by those skilled in the art, a spline may be a substantially smooth, piecewise polynomial or parametric curve function. A velocity spline may encode a desired vehicle velocity as a function of time, and a directional spline may encode a desired vehicle direction such as a steering angle or a vehicle heading as a function of time.

A current trajectory and trajectory updates 548 may define or encode a desired vehicle position as a function of coordinates over time, e.g., as an x-direction position as a function of time and a y-direction position as a function of time. The current trajectory and trajectory updates 548 may include or encode other functions of vehicle dynamics including, but not limited to including, derivatives of velocity and directional splines, such as an acceleration spline or a derivative of a velocity spline and a jerk spline such as a derivative of an acceleration spline.

As mentioned above, trajectory update validation and arbitration arrangement 438d′ may validate trajectory updates 548 based on any suitable criteria including, but not limited to including, a current trajectory of vehicle 501. By way of example, trajectory updates 548 may be validated based upon whether components such as a velocity spline or a directional spline satisfy one or more value criteria such as a maximum or minimum velocity limit, and/or whether one or more timing criteria are satisfied to substantially ensure that trajectory updates 548 are in sync with a current trajectory. The validation of trajectory updates 548 may involve ascertaining whether trajectory updates 548 are consistent with a current vehicle status, e.g., a current drivetrain gear direction. Trajectory updates 548 may also be validated based upon whether following the trajectory would cause vehicle 501 to substantially violate dynamic limits of vehicle 501, e.g., by causing vehicle 501 to exceed a speed limit.

Trajectory update validation and arbitration arrangement 438d′ may use arbitration to select a particular trajectory update 548 to utilize to update a current trajectory followed by vehicle 501. Trajectory updates 548 may be ranked or prioritized based on their respective source or trajectory generation system 550. That is, sources of trajectory updates 548 may have a substantially predefined prioritization, e.g., a trajectory update 548 from secondary compute 550b may generally be prioritized over a trajectory update 548 from main compute 550a. In one embodiment, sources may be ranked such in an order such that a highest priority is associated with remote control interface 550c, a next highest priority is associated with a teleoperations interface of secondary compute 550b, a next highest priority is associated with a backup autonomy system of secondary compute 550b, and a lowest priority is associated with an autonomy system of main compute 550a. It should be appreciated that priorities may be substantially augmented with other considerations such as a connection health status, such as a cellular signal strength, latency, and/or bandwidth, to effectively modify priorities. In other words, the priorities associated with trajectory generation system 550 may be dynamic and may change based upon a variety of different factors.

When an issue is detected, issue determination arrangement 438a′ may classify the issue, and trajectory updates 548 may be substantially processed according to the classification of the issue. In one embodiment, the detected issue may be an issue with trajectory generation system 550. Typically, if the issue is identified as a non-critical issue, the indication is that vehicle 501 may continue to operate safely. As such, if the issue is non-critical, vehicle control system 338′ may continue to obtain trajectory updates 548 from trajectory generation system 550, and vehicle 501 may continue to operate autonomously or semi-autonomously. If an issue is identified as a critical fault, the indication is that vehicle 501 may not be able to safely operate, and vehicle control system 338′ may effectively disregard newer trajectory updates 548 from trajectory generation system 550, and vehicle systems 546 such as a braking system may be engaged to bring vehicle 501 to a stop. When newer nominal trajectory updates are disregarded, a safe stop that is published by an autonomy system may instead to executed. Such a safe stop trajectory may be, but is not limited to being, a hard braking or hard veering type of maneuver. In the event that an issue is neither non-critical nor critical, e.g., when an issue is an intermediate issue, vehicle 501 may perform a controlled autonomous safe stop within a predetermined or prescribed amount of time, as for example a TCAS time interval as substantially specified by TCAS timer arrangement 438f.

When a detected issue is considered to be neither non-critical nor critical, vehicle control system 338′ may engage in communications with trajectory generation system 550. The communications may include, but are not limited to including, information associated with the detected issue, information associated with a TCAS time interval, and/or information associated with performance limits of vehicle 501 associated with the performance of a safe stop or TCAS. Given the information provided in the communications, trajectory generation system 550 may generate one or more trajectory updates 548 that may enable vehicle 501 to come to a safe stop within a TCAS time interval. During the TCAS time interval, or an amount of time between approximately when an issue was detected and a time by which vehicle 501 is to come to a safe stop, vehicle control system 338′ may continue to obtain or otherwise receive trajectory updates 548 from trajectory generation system 550. After the TCAS time interval elapses or if vehicle 501 is brought to a safe stop before the TCAS time interval elapses, vehicle control system 338′ may effectively reject additional trajectory updates 548. Rejecting or declining additional trajectory updates 548 may substantially ensure that vehicle 501 remains safely stopped, e.g., may prevent vehicle 501 from processing a trajectory update 548 that may involve vehicle 501 once again driving. In other words, once vehicle 501 has come to a stop after an issue is detected or otherwise identified, vehicle 501 may effectively be prevented from moving until the issue is resolved.

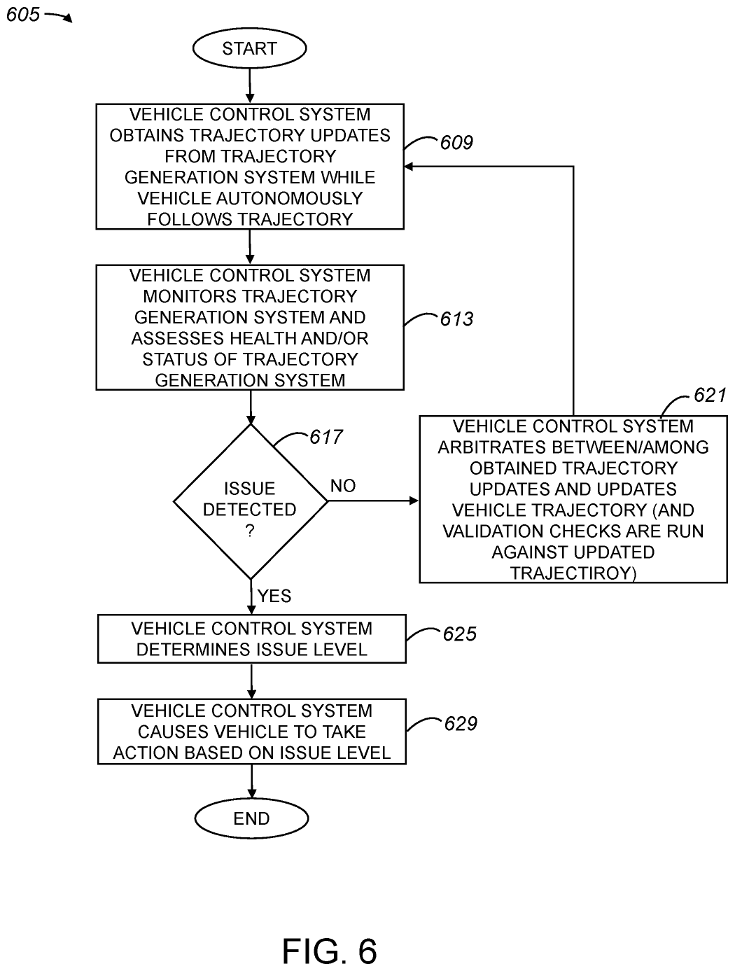

In one embodiment, a vehicle control system of a vehicle may detect or otherwise identify an issue, e.g., an issue with a trajectory generation system, while the vehicle is following a current trajectory, or is otherwise operating. FIG. 6 is a process flow diagram which illustrates a method of a vehicle control system operating in accordance with an embodiment. A method 605 of a vehicle control system operating begins at a step 609 in which a vehicle control system of a vehicle obtains trajectory updates from a trajectory generation system while the vehicle autonomously follows a current trajectory. That is, the vehicle control system obtains trajectory updates which may be used to update the current trajectory that the vehicle may be following.

In a step 613, the vehicle control system monitors the trajectory generation system. The vehicle control system monitors the trajectory generation system to substantially assess the health and/or the status of the trajectory generation system. Assessing the health and/or status of a trajectory generation system may include, but is not limited to including, determining whether there is an issue with an autonomy system of a main compute of the vehicle, determining whether there is an issue with a backup autonomy system or a teleoperations interface of a secondary compute of the vehicle, and/or determining whether there is an issue with a remote control interface of the vehicle.

A determination is made in a step 617 as to whether an issue has been detected. In the described embodiment, it is determined whether the vehicle control system has identified one or more issues associated with the trajectory generation system. If it is determined that an issue has not been detected, then process flow moves to a step 621 in which the vehicle control system arbitrates between or among obtained trajectory updates, and updates the current vehicle trajectory using one or more of the obtained trajectory updates. Typically, after the vehicle control system arbitrates among obtained trajectory updates, and selects or updates a vehicle trajectory, validation checks may be run against the selected or updated vehicle trajectory. After the vehicle trajectory is updated, process flow returns to step 609 in which the vehicle control system obtains trajectory updates.

Alternatively, if it is determined in step 617 that an issue has been detected, then the vehicle control system determines an issue level in a step 625. In one embodiment, there may be three issue levels, although it should be appreciated that the number of issue levels may vary widely. The three issue levels may be a non-critical or non-urgent level, a critical or urgent level, and an intermediate level that is less critical than a critical level but more critical than a non-critical level.

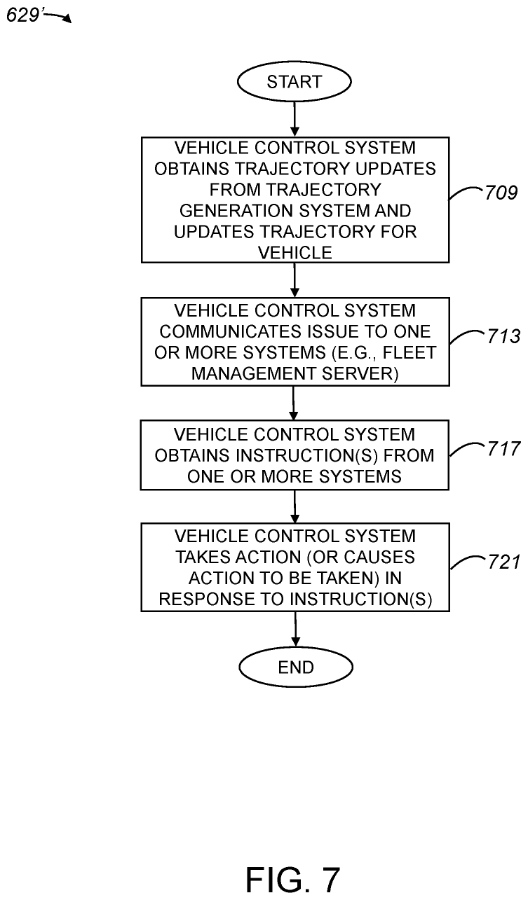

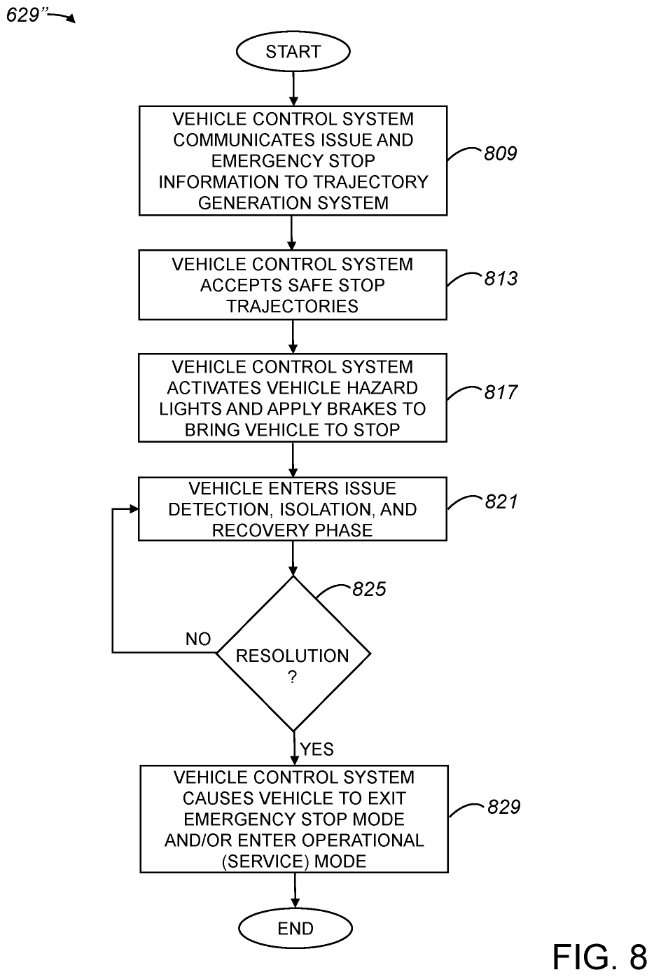

Once the vehicle control system determines an issue level, the vehicle control system causes the vehicle to take one or more actions based on the issue level in a step 629. That is, the vehicle control system causes the vehicle to respond to the issue in a manner that is consistent with the criticality or urgency of the issue. Step 629 will be described in more detail below with respect to FIGS. 7, 8, and 9A-C. After the vehicle control system causes the vehicle to take one or more actions based on the issue level, the method of a vehicle control system operating is completed.

When an issue detected by a vehicle control system of a vehicle is not relatively critical, urgent, or severe, the vehicle may generally continue to operate safely, FIG. 7 is a process flow diagram which illustrates a method of a vehicle control system causing a vehicle to take an action based on a non-critical or non-urgent issue, e.g., step 629 of FIG. 6, in accordance with an embodiment. Method 629′ of causing a vehicle to take an action begins at a step 709 in which, after a vehicle control system identifies an issue as being non-critical or non-urgent, the vehicle control system obtains trajectory updates from a trajectory generation system, and updates the trajectory for the vehicle.

Once the vehicle control system updates the trajectory for the vehicle, the vehicle control system communicates the issue to one or more systems in a step 713. That is, the vehicle control system may provide information relating to the issue to a system such as a fleet management server, an autonomy system, and/or a teleoperations system. The information relating to the issue may identify the issue, and also identify the issue as being non-critical or non-urgent. The information may be logged by the one or more systems.

In a step 717, the vehicle control system may obtain one or more instructions from the one or more systems that obtained information relating to the issue from the vehicle control system. In other words, the vehicle control system may obtain instructions which substantially indicate how to respond to the issue.

After the vehicle control system obtains one or more instructions, the vehicle control system takes at least one action, or causes at least one action to be taken, in response to the one or more instructions in a step 721. By way of example, the instructions may cause the vehicle to change the velocity or speed at which the vehicle is driving. The method of causing a vehicle to take an action is completed once at least one action is taken in response to the one or more instructions.

With reference to FIG. 8, a method of a vehicle control system causing a vehicle to take an action based on a critical or urgent issue, e.g., step 629 of FIG. 6, will be described in accordance with an embodiment. Method 629″ of causing a vehicle to take an action begins at a step 809 in which a vehicle control system of the vehicle communicates the issue and emergency stop information to a trajectory generation system. In one embodiment, the vehicle control system may also communicate the issue and emergency stop information to other systems, e.g., a fleet management system.

In a step 813, the vehicle control system accepts substantially only safe stop trajectories provided by the trajectory generation system. Then, in a step 817, the vehicle control system activates vehicle hazard lights and applies brakes to bring the vehicle to a stop. Bringing the vehicle to an emergency stop effectively causes the vehicle to enter an emergency stop mode. In one embodiment, the emergency stop may be performed at approximately the location the vehicle as located at the time the issue was identified.

After the vehicle comes to a stop, the vehicle may enter an issue detection, isolation, and recovery phase in a step 821. For example, the vehicle may await a repair crew that may address the vehicle at the location at which the vehicle is stopped, or await an extraction team that may transport the vehicle to a different location at which the issue may be addressed. The vehicle may effectively await a resolution which may lead to a recover.

A determination is made in a step 825 as to whether there has been a resolution to the issue. If the determination is that the issue has not been resolved, the vehicle continues to await resolution in step 821. Alternatively, if the determination is that the issue has been resolved, then in a step 829, the vehicle control systems causes the vehicle to substantially exit the emergency stop mode, and/or causes the vehicle to enter an operation mode, e.g., a service mode. The method of causing a vehicle to take an action is completed after the vehicle exits the emergency stop mode and/or enters an operational mode.

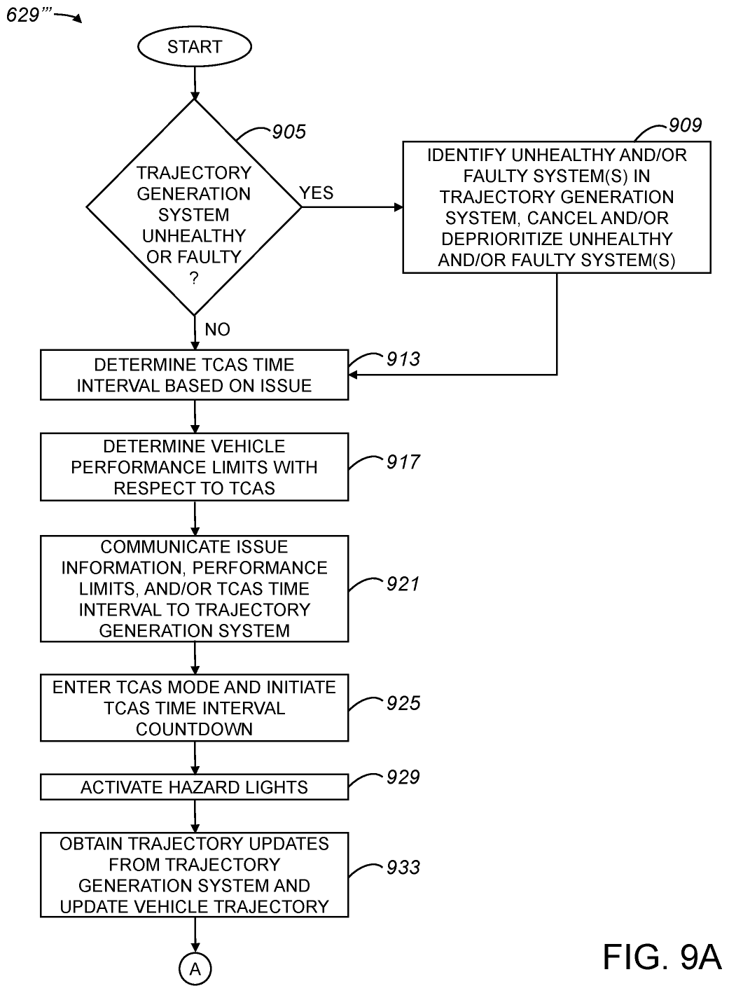

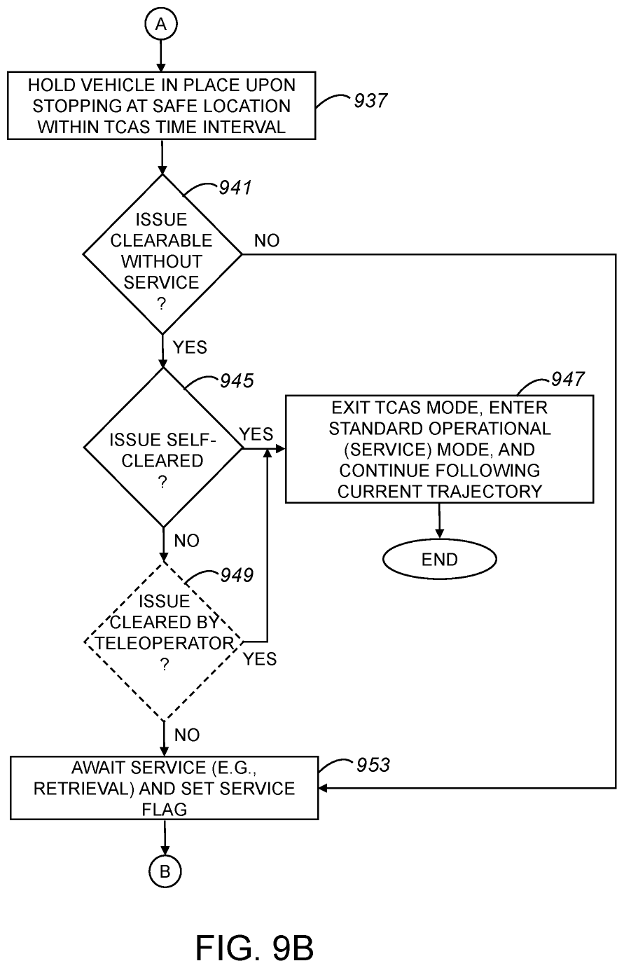

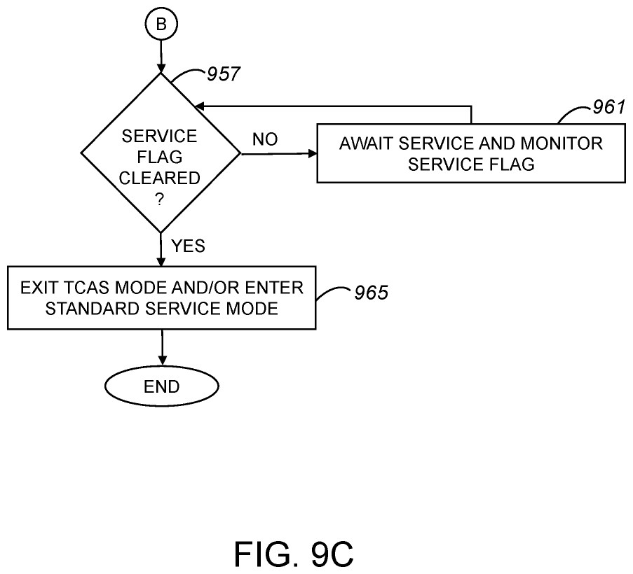

As mentioned above, some issues detected by a vehicle control system may be neither highly critical nor non-critical. Such issues may be considered intermediate issues, or issues that are on a spectrum of criticality between highly critical issues and non-critical issues. Referring next to FIGS. 9A-C, a method of a vehicle control system causing a vehicle to take an action based on an intermediate issue, e.g., step 629 of FIG. 6, will be described in accordance with an embodiment. Method 629′ begins at a step 905 in which a vehicle control system of a vehicle determines whether a detected issue indicates that a trajectory generation system is unhealthy and/or faulty. That is, the vehicle control system effectively ascertains whether the trajectory generation system is capable of operating as expected.

If the determination in step 905 is that the trajectory generation system is unhealthy and/or faulty, the one or more unhealthy and/or faulty systems in the trajectory generation system may be identified, and parameters associated with generating a trajectory may be set to deprioritize or cancel trajectory updates generated by the one or more unhealthy and/or faulty systems in a step 909. For example, trajectory updates from one or more unhealthy and/or faulty systems included in a trajectory generation system may be substantially ignored.

After trajectory updates from one or more unhealthy and/or faulty systems are canceled and/or deprioritized, a TCAS time interval is determined in a step 913 using information associated with the issue. That is, a time frame within which the vehicle is to come to a stop may be identified or otherwise defined. The vehicle is expected to come to a stop during the TCAS time interval, or before the TCAS time interval expires.

Returning to step 905 and the determination of whether the trajectory generation system is unhealthy and/or faulty, if the determination is that the trajectory generation system is healthy, then process flow moves from step 905 to step 913 in which a TCAS time interval is determined. After the TCAS time interval is defined, vehicle performance limits are determined by the vehicle control system in a step 917 with respect to the TCAS time interval. The vehicle performance limits may include, but are not limited to including, a maximum velocity, a minimum velocity, a maximum acceleration, a minimum acceleration, and/or a substantially maximum distance the vehicle may be able to travel based on fuel or power levels.

In a step 921, the vehicle control system communicates information about the issue, performance limits, and/or the TCAS time interval to the trajectory generation system. Once the vehicle control system communicates information to the trajectory generation system, the vehicle control system enters into a TCAS mode, and initiates a TCAS time interval countdown in a step 925.

After the vehicle control system initiates a TCAS time interval countdown, the vehicle control systems causes hazard lights on the vehicle to activate in a step 929. Then, in a step 933, the vehicle control system obtains trajectory updates form the trajectory generation system, and updates the trajectory based on the trajectory updates. It should be appreciated that one or more trajectory updates may be arranged to enable the trajectory to be updated such that the trajectory includes the safe location at which the vehicle may stop.

Within the TCAS time interval, the vehicle stops at a safe location in a step 937 and is effectively held in place at the safe location. In other words, once the vehicle stops at a safe location, the vehicle remains at the safe location, at least until the issue is substantially cleared.

A determination is made in a step 941 as to whether the issue may be cleared without service, e.g., service such as a maintenance repair. If the determination is that the issue may be cleared without service, it is determined in a step 945 whether the issue has essentially self-cleared. It should be appreciated that upon stopping at a safe location the vehicle control system may cause actions to be taken to resolve the issue. For example, devices on the vehicle may be rebooted to resolve the issue.

If the determination in step 945 is that the issue has self-cleared, or otherwise substantially cleared itself, then process flow moves to a step 947 in which the vehicle control system exits a TCAS mode, enters a standard operational or service mode, and continues following a current trajectory. The method of causing a vehicle to take an action is completed after the vehicle enters a standard operation mode and continues following a current trajectory.

Alternatively, if it is determined in step 945 that the issue has not self-cleared, a determination is made in an optional step 949 as to whether the issue has been cleared by a teleoperator operating a teleoperations system that is in communication with the vehicle. If it is determined that the issue has been cleared by a teleoperator, then in step 947, the vehicle control system exits a TCAS mode, enters a standard operational mode, and continues following a current trajectory.

On the other hand, if it is determined in step optional 949 that the issue has not been cleared by a teleoperator, the implication is that although the issue may be clearable without service, the issue has not been successfully cleared. Accordingly, process flow proceeds from optional step 949 to a step 953 in which the vehicle awaits service or assistance, e.g., a retrieval or extraction from the safe location, and sets a service flag. By setting a service flag, and communicating the service flag to one or more systems such as a fleet management server, the vehicle control system effectively requests assistance.

It should be appreciated that when there is no teleoperations system in communication with the vehicle, process flow moves directly from step 945 to step 953 if the determination in step 945 is that the issue has not self-cleared. In step 953, the vehicle awaits service or assistance.

A determination is made in a step 957 whether the service flag is cleared. If the service flag is cleared, the indication is that service has been completed with respect to addressing the issue. In one embodiment, after performing service, a technician that, performed the service may cause the service flag to be cleared. If it is determined that the service flag is not cleared, the vehicle awaits service and the vehicle control system continues to essentially monitor the service flag in a step 961. From step 961, process flow returns to step 957 in which it is determined whether the service flag is cleared.

Alternatively, if the determination in step 957 is that the service flag is cleared, then in a step 965, e vehicle control system exits the TCAS mode and/or enters an operational service mode. Upon entering the operational service mode, the method of causing a vehicle to take an action is completed.

Returning to step 941 and the determination of whether the issue may be cleared without service, if it is determined that the issue may not be cleared without service, the indication may be that service such as maintenance or a repair may be needed. As such, process flow moves from step 941 to step 953 in which the vehicle awaits service, and a service flag is set.

An issue level determination arrangement, as discussed above, may identify an issue such as a fault, and determine whether a level or tier for the issue is critical, non-critical, or intermediate. In one embodiment, issue level determination arrangement may obtain information from an issue management arrangement or system that is generally configured to manage issues, and to substantially generate issue mappings that are stored in an issue table arrangement. With reference to FIG. 10, an issue or fault level determination arrangement, e.g., issue level determination arrangement 438a of FIG. 4, will be described in accordance with an embodiment. Issue determination arrangement 438″ includes a processing module 1080a, a table indexing module 1080b, a trajectory instruction module 1080c, and a timer instruction module 1080d. Modules or systems 1080a-d may be embodied to include hardware, e.g., circuits, and/or software logic embodied in a computer-readable medium.

Processing module 1080a may be embodied to include an electronic circuit that performs calculations that include arithmetical and/or logical instructions. In one embodiment, processing module 1080a may obtain and process issue identification information 1078 provided to issue level determination arrangement 438a″ by a local issue or fault manager 1070. Processing module 1080a may process issue identification information 1078, and identify the issue that has been detected. Table indexing module 1080b uses the identity of the issue to index into a table, or to otherwise obtain a mapping between the issue and a criticality level associated with the issue. Table indexing module 1080b may also be arranged to obtain information relating to an action that is suitable to take based on the criticality level associated with the issue from the table. Trajectory instruction module 1080c may be configured to provide information associated with the issue, and to provide the information to a trajectory update validation and arbitration arrangement such as trajectory update validation and arbitration arrangement 438d of FIG. 4, as appropriate. Timer instruction module 1080d may be configured to communicate timing information, e.g., an amount of time before a vehicle is to come to a stop in response to an intermediate level issue, to a TCAS timer arrangement such as TCAS timer arrangement 438f of FIG. 4.

Local issue manager 1070 is configured to obtain information relating to systems on a vehicle, and to facilitate addressing the issue. In one embodiment, local issue manager 1070 obtains issue and/or health status information 1074 from systems on a vehicle, process issue and/or health status information 1074, and provides issue identification information 1078 to issue level determination arrangement 438a″.

Although only a few embodiments have been described in this disclosure, it should be understood that the disclosure may be embodied in many other specific forms without departing from the spirit or the scope of the present disclosure. By way of example, while the classification of issues such as failures or faults has been described as including approximately three classes or tiers of severity, issues are not limited to being categorized into approximately three classes. The number of categories or issues may vary widely, and the corresponding actions or actions to take for each of the categories may also vary.

Factors used to determine whether an issue is if a critical level, a non-critical level, or an intermediate level may vary widely. The factors may be dynamic, and may be changed based on parameters set by an enterprise deploying or otherwise managing one or more vehicles. Further, an issue identified as critical by one enterprise may not be considered to be critical by another enterprise.

A local issue or fault manager, e.g., local issue or fault manager 1070 of FIG. 10, may provide information to other systems associated with a vehicle in addition to providing information to an issue level determination arrangement. Further, a local issue or fault manager may coordinate a reaction to an issue and facilitate arbitration of escalation levels associated with an issue.

For some issues, an autonomy system may determine the best course of action to handle the issue. That is, the autonomy system may be substantially expected to resolve an issue that is identified by a fault manager. Fir example, an autonomy system may be expected to resolve relatively minor issues such as minor deviations identified between a commanded trajectory and actual vehicle motion. In one embodiment, an issue such as a brake pad warning may have a relatively low issue or fault level, and an autonomy system may be provided with an indication of the issue or otherwise informed of the issue. The brake pad warning on a vehicle may result in the vehicle being flagged for service at a later time, although if the warning becomes an alarm, then the vehicle may execute a stopping maneuver.

An autonomous vehicle has generally been described as a land vehicle, or a vehicle that is arranged to be propelled or conveyed on land. It should be appreciated that in some embodiments, an autonomous vehicle may be configured for water travel, hover travel, and or/air travel without departing from the spirit or the scope of the present disclosure. In general, an autonomous vehicle may be any suitable transport apparatus that may operate in an unmanned, driverless, self-driving, self-directed, and/or computer-controlled manner.

In general, while an autonomous vehicle has been described as being arranged to transport goods, it should be appreciated that an autonomous vehicle may additionally, or alternatively, be configured to transport passengers. That is, an autonomous vehicle is not limited to transporting goods. When an autonomous vehicle has occupants such as passengers, addressing detected issues may generally account for the safety of the occupants.

The embodiments may be implemented as hardware, firmware, and/or software logic embodied in a tangible, i.e., non-transitory, medium that, when executed, is operable to perform the various methods and processes described above. That is, the logic may be embodied as physical arrangements, modules, or components. For example, the systems of an autonomous vehicle, as described above with respect to FIG. 3, may include hardware, firmware, and/or software embodied on a tangible medium. A tangible medium may be substantially any computer-readable medium that is capable of storing logic or computer program code which may be executed, e.g., by a processor or an overall computing system, to perform methods and functions associated with the embodiments. Such computer-readable mediums may include, but are not limited to including, physical storage and/or memory devices. Executable logic may include, but is not limited to including, code devices, computer program code, and/or executable computer commands or instructions.

It should be appreciated that a computer-readable medium, or a machine-readable medium, may include transitory embodiments and/or non-transitory embodiments, e.g., signals or signals embodied in carrier waves. That is, a computer-readable medium may be associated with non-transitory tangible media and transitory propagating signals.

The steps associated with the methods of the present disclosure may vary widely. Steps may be added, removed, altered, combined, and reordered without departing from the spirit of the scope of the present disclosure. For instance, when an issue detected by a vehicle control system of a vehicle is an intermediate issue that may be cleared by the vehicle or a teleoperator, a determination of whether the issue has been cleared is not limited to occurring after the vehicle is stopped in a safe location. The present examples are to be considered as illustrative and not restrictive, and the examples are not to be limited to the details given herein, but may be modified within the scope of the appended claims.

What is claimed is:

1. A method comprising:
identifying, using a vehicle control system (VCS) of a vehicle, an issue associated with the vehicle, the vehicle including a trajectory generation system, the vehicle being configured to follow a trajectory generated by the trajectory generation system;
determining, using the VCS, a criticality level of the issue;
determining, using the VCS, at least one action to perform with respect to the vehicle, the at least one action being associated with the criticality level, wherein determining the at least one action to perform includes determining whether to accept a first trajectory update generated by the trajectory generation system; and
performing the at least one action, wherein performing the at least one action includes updating the trajectory using the first trajectory update when it is determined that the first trajectory update is be accepted, and wherein performing the at least one action further includes declining the first trajectory update when it is determined that the first trajectory update is not to be accepted.

2. The method of claim 1 wherein the criticality level includes at least a critical level, an intermediate level, and a non-critical level, wherein when the criticality level is the critical level, performing the at least one action includes declining the first trajectory update.

3. The method of claim 2 wherein when the criticality level is the critical level, performing the at least one action further includes causing the vehicle to come to a stop.

4. The method of claim 1 wherein when the criticality level is one selected from a group including the intermediate level and the non-critical level, performing the at least one action includes updating the trajectory using the first trajectory update.

5. The method of claim 4 wherein when the criticality level is the non-critical level, performing the at least one action further includes obtaining at least one instruction in response to the issue and performing the at least one instruction.

6. The method of claim 4 wherein when the criticality level is the intermediate level, performing the at least one action further includes:
determining a time interval during which the vehicle is to be stopped;
determining at least one performance limit associated with stopping the vehicle during the time interval;
providing the time interval and the at least one performance limit to the trajectory generation system;
generating at least a second trajectory update based on at least the time interval and the at least one performance limit using the trajectory generation system; and
updating the trajectory based on the at least second trajectory update using the trajectory generation system.

7. The method of claim 1 wherein the issue is one selected from a group including a fault, a failure, an error, an exception, and a performance degradation associated with the trajectory generation system.

8. A vehicle including logic encoded in one or more tangible non-transitory, computer-readable media for execution and when executed operable to:
generate a trajectory to be followed by the vehicle, wherein the logic operable to generate the trajectory is further operable to generate at least a first trajectory update and to use the first trajectory update to update the trajectory;
identify an issue associated with the vehicle;
determine a criticality level of the issue;
determine at least one action to perform with respect to the vehicle, the at least one action being associated with the criticality level, wherein the logic operable to determine the at least one action to perform is operable to determine whether to accept the first trajectory update; and
perform the at least one action, wherein the logic operable to perform the at least one action includes logic operable to update the trajectory using the first trajectory update when it is determined that the first trajectory update is be accepted, and wherein the logic operable to perform the at least one action is further operable to decline the first trajectory update when it is determined that the first trajectory update is not to be accepted.

9. The vehicle of claim 8 wherein the criticality level includes at least a critical level, an intermediate level, and a non-critical level, wherein when the criticality level is the critical level, the logic operable to perform the at least one action is further operable to decline the first trajectory update.

10. The vehicle of claim 9 wherein when the criticality level is the critical level, the logic operable to perform the at least one action is further operable to cause the vehicle to come to a stop.

11. The vehicle of claim 8 wherein when the criticality level is one selected from a group including the intermediate level and the non-critical level, the logic operable to perform the at least one action is further operable to update the trajectory using the first trajectory update.

12. The vehicle of claim 11 wherein when the criticality level is the non-critical level, the logic operable to perform the at least one action is further operable to obtain at least one instruction in response to the issue and to perform the at least one instruction.

13. The vehicle of claim 11 wherein when the criticality level is the intermediate level, the logic operable to perform the at least one action is further operable to:
determine a time interval during which the vehicle is to be stopped;
determine at least one performance limit associated with stopping the vehicle during the time interval;
generate at least a second trajectory update based on at least the time interval and the at least one performance limit; and
update the trajectory based on the at least second trajectory update.

14. The vehicle of claim 8 wherein the issue is one selected from a group including a fault, a failure, an error, an exception, and a performance degradation associated with the vehicle.

15. A vehicle comprising:
a chassis;
a propulsion system configured to propel the chassis;
a trajectory generation system, the trajectory generation system configured to generate at least one trajectory update, the trajectory generation system further configured to generate a trajectory to be followed by the vehicle; and
a vehicle control system, the vehicle control system includes a trajectory execution arrangement configured to execute the trajectory, wherein the vehicle control system further includes an issue determination arrangement configured to identify an issue associated with the trajectory generation system, to identify a category for the issue, and to perform at least one action based on the category.

16. The vehicle of claim 15 wherein the category is one selected from a group including a critical level, an intermediate level, and a non-critical level, wherein when the category is the critical level, the trajectory execution arrangement declines a first trajectory update and the vehicle control system causes the vehicle to come to a stop.

17. The vehicle of claim 15 wherein the category is one selected from a group including a critical level, an intermediate level, and a non-critical level, wherein when the category is the non-critical level, the trajectory execution arrangement accepts a first trajectory update and the vehicle control system takes an action based on an instruction provided in response to the issue.

18. The vehicle of claim 15 wherein the vehicle control system includes a timer arrangement, the category being one selected from a group including a critical level, an intermediate level, and a non-critical level, and wherein when the category is the intermediate level, the timer arrangement determines a time interval during which the vehicle is to be stopped and the vehicle control system determines at least one performance limit associated with stopping the vehicle during the time interval.

19. The vehicle of claim 18 wherein the vehicle control system is configured to provide the time interval and the at least one performance limit to the trajectory generation system and the trajectory generation system is configured to generate at least a second trajectory update based on at least the time interval and the at least one performance limit.

20. The vehicle of claim 15 wherein the issue is one selected from a group including a fault, a failure, an error, an exception, and a performance degradation associated with the trajectory generation system, and wherein the vehicle further includes a local issue manager arranged to provide information about the issue to the issue determination arrangement.
